(19) United States
(12) Patent Application Publication
(10) Pub. No.: US 2008/0299287 A1
(43) Pub. Date: Dec. 4, 2008

(54) Process For The Recovery Of A Brown Food-Grade Sugar Product From A Sugar Beet Solution

(75) Inventors: Melvin P. Carter, Maribo (DK); John Preben Jensen, Nakskov (DK)

Correspondence Address: SCULLY SCOTT MURPHY & PRESSER, PC, 400 GARDEN CITY PLAZA, SUITE 300, GARDEN CITY, NY, 11530, US

(73) Assignee: DANISCO SUGAR A/S, Copenhagen K (DK)

(21) Appl. No.: 12/158,724

(22) PCT Filed: Dec. 20, 2006
(86) PCT No.: PCT/EP2006/070008

§ 371 Date: Jul. 28, 2008

(30) Foreign Application Priority Data
Dec. 21, 2005 (GB) 0526034.4

(51) Int. Cl. A23G 3/00; B01D 59/42

(52) U.S. Cl. 426/660; 204/544; 426/658

(57) ABSTRACT

The invention relates to an industrially useful process for the recovery of sucrose and/or non-sucrose components. The process comprises (i) providing a solution of sugar beet and/or sugar cane origin selected from molasses, sugar juices and liquors, wherein said sugar juices are non-nanofiltered during the process; (ii) subjecting said solution to electrodialysis for removing therefrom inorganic and organic anions and cations and organic acids; (iii) subjecting the electrodialyzed solution to a chromatographic separation for obtaining sucrose and non-sucrose components in separate fractions; and (iv) recovering a product selected from sucrose and non-sucrose components from at least one of said fractions. The invention also relates to the use of electrodialysis for improving the efficiency of chromatographic separation in the industrial recovery of sucrose and/or non-sucrose components.

### FIELD OF THE INVENTION

The present invention relates to the field of sugar manufacturing industry and flavouring industry. More particularly, the invention relates to a process for the recovery of a brown food-grade sugar product from sugar beet solutions, which can be obtained from various beet sugar process streams, such as thin juice, thick juice and molasses. The invention also relates to novel food-grade beet sugar products derived from a sugar beet solution. The products of the invention are suitable for substituting the corresponding cane sugar derived products. The products according to the invention can be selected from brown sugar, electrodialyzed molasses, treacle, syrup and combinations thereof. Especially the invention relates to the production of food-grade beet molasses. The invention also relates to edible products comprising said novel food-grade beet sugar products. In a further aspect the invention relates to the use of electrodialysis for removing malodorous volatile components from a sugar beet solution.

### BACKGROUND OF THE INVENTION

Molasses is the final syrup residue remaining after crystallisation of sugar from either cane or beet juices. Only the syrup left from the final crystallisation stage is called molasses; intermediate syrups are referred to as high green and low green and these are recycled within the crystallisation process to maximise extraction. Molasses is one of the most valuable by-products of the sugar manufacturing process. Both beet and cane molasses are widely used in the fermentation industries and in animal feed but only cane molasses as a food ingredient.

Molasses that comes from the sugar beet is different from cane molasses. Beet molasses contains over 50% sugar by dry weight, predominantly sucrose but also containing small amounts of glucose and fructose. The non-sugar content includes e.g. amino acids, organic acids, and many salts such as calcium, potassium, oxalate and chloride. These are either as a result of concentration from the original plant material or as a result of chemicals used in the processing. As such, beet molasses is generally known to be very unpalatable and is mainly used as an additive to animal feed or as a fermentation feedstock. Therefore, as an ingredient of food grade speciality brown sugars and molasses blends, only syrups of cane origin are used (Sugar Technology Beet and Cane Sugar Manufacture, P. W. van der Poel, H Schiweck, T. Schwartz, 1998, p 967 section 19.6). Known substitutes in bakery product for syrups of cane origin are corn syrup, pure maple syrup or even honey. However, these are more expensive than cane molasses. One of the aspects of this invention is the production of palatable syrup of beet origin suitable as an ingredient in brown sugars and brown syrups. This is done with the aid of electrodialysis.

It is well known that pyrazines found in beet molasses do not exist in cane molasses and are one of the compounds distinguishing these two products. Pyrazines are formed in alkaline conditions in the presence of glucose and amino acids, which have great chemical reactivity with respect to carbonyl compounds, through the Maillard reaction. Beet juices contain much higher levels of amino acids than cane juice (Sugar Technology Beet and Cane Sugar Manufacture, P. W. van der Poel, H Schiweck, T. Schwartz, 1998, p 143 and 156) in which many of the amino acids are only present in trace amounts. The higher levels of amino acids in beet juices and the higher operating pH in the conventional beet sugar process are two factors which can explain the presence of pyrazines in sugar beet juices like thin juice, thick juice and molasses.

Pyrazines are known to be powerful aroma compounds with odours ranging from nutty, roasted, musty, to burnt solvent. Identification and quantification by Marsili et al (Journal of Chromatographic Science, 1994, 32, 165-171) of compounds responsible for the off-odour of beet sugar identified 2,5-dimethyl pyrazine as one of the compounds likely to contribute to the characteristic off-odour of beet sugar. Marsili found also geosmin, acetic, butyric and isovaleric acids to produce odour characteristics of beet. Carbon treatment reduced acetic acid and also acetol levels. Acetol has a good odour, but is pungent in larger quantities.

Electrodialysis (ED) as a technique is known from the 1950's and it is widely used for example in desalting of water and whey and within the inorganic chemical industry e.g. for recovering organic acids from solutions. Desalting of sugar cane or sugar beet solutions via ED has been established in 1960's to 80's in various patent publications. Electrodialysis separates salts from a sugar solution using alternate cation and anion exchange membranes. This is done by passing a direct current through a membrane stack, causing the anions to move through the anion exchange membrane and the cations through the cation exchange membrane. The cations cannot move through the anion exchange membrane.

U.S. Pat. No. 3,799,806 discloses a process for the purification and clarification of sugar juices, involving ultrafiltration followed by purification with electrodialysis. Sugar is separated by crystallisation from the purified juice.

U.S. Pat. No. 3,781,174 discloses a continuous process for producing refined sugar from juice extracted from sugarcane. This process comprises further removing the impurities and colouring matter by using a combination of ion-exchange resin and ion-exchange membrane electrodialysis, concentrating the purified juice and crystallizing the concentrated juice to form refined sugar.

U.S. Pat. No. 4,331,483 discloses a process for purifying beet juice by contacting the juice to be purified with at least two ion exchangers formed of a porous mineral support covered with a film of cross-linked polymer containing or bearing quaternary ammonium salt groups for at least one of the ion exchangers and sulfone groups for at least one of the other ion exchangers. The ion exchange is used for removing proteins, amino acids and betaine. Further, the purified juice might be demineralized by ion exchange or electrodialysis. Sugar is then separated by crystallisation from the purified juice.

U.S. Pat. No. 4,083,732 discloses a method of treating fresh sugar cane juice at about room temperature which includes removing non-sugar impurities, concentrating the resulting cold, water white juice by reverse osmosis to form a syrup which is evaporated to form direct white sugar and edible molasses. Also a method of removing ions from the syrup by electrodialysis to produce cane based edible molasses having a very low ash and maple flavour is disclosed.

WO2003/018848 describes a process for the preparation of white and brown sugar from raw diffuser beet juice. The juice is purified by membrane filtration at 70 to 95° C. on a filter having a cut-off between 2,000 and 500,000 Dalton and evaporated under vacuum to a thick juice. After concentration to dry matter content of 25% to 35% by weight the membrane filtrated juice can optionally be demineralized by electrodialysis and then further evaporated to a thick juice. A conventional multi-step evaporative crystallisation of the thick juice gives crops of white and brown sugar crystals. The brown sugar obtained has valuable organoleptic properties and produced molasses has a better taste and aroma than conventional beet molasses. The removal of non-sugar impurities by cross-flow membrane filtration of the raw juice instead of carbonation leaves another pattern of created and remained impurities. Thus some impurities, which were removed by the conventional carbonation process, will remain in the juice and the others like pyrazines are not formed at all in this process.

Thus, electrodialysis is known as a method for desalinating sugar cane syrup or molasses of a relatively high concentration. In case of sugar syrup or molasses, however, it has been considered defective in that organic non-sugar contents would adhere to and precipitate on the anion exchange film and make cleaning of films difficult. A method for the reduction of fouling by the precipitation of calcium and silicon before electrodialysis is disclosed in U.S. Pat. No. 4,492,601. It describes a process for clarifying and desalinating sugar cane syrup or molasses, wherein inorganic oxy-acid and organic acid impurities are removed from raw sugar cane or molasses solutions by the steps of (1) admixing with the raw sugar cane syrup or molasses solution a water-soluble chloride of an alkaline earth metal ion which reacts with inorganic oxy-acid anions and radicals and with organic acids to form a water-insoluble precipitate of said oxy-acid anions and radicals and organic acids, (2) separating said precipitate from said solution, (3) diluting the precipitate-free solution, and (4) subjecting said diluted solution to an electrodialysis using cation exchange film and neutral film arranged in an alternating manner.

The article “New technologies in the sugar industry” by Matild Eszterle (Cukoripar liv vol 54, (2001) No 1, pp 4-10) discloses separation techniques used in sugar industry including chromatography and electrodialysis. These techniques are disclosed as alternatives for the purification of sugar juices. This article does not disclose any specific combination of these techniques and it is only directed to provide a method which would decrease the number of energy consuming crystallisation steps.

ED has not commonly been used until late 1990's in sugar industry due to its high capital costs and due to fouling problems caused by anion products removed by ED from molasses. Various extensive pre-treatment methods to overcome the fouling problem have been patented, e.g. U.S. Pat. No. 4,711,722 and JP 58-082124.

The development of fouling resistant and high temperature resistant anion exchange membranes and the design of electrodialysis stacks has facilitated the economical use of ED in the sugar industry. Eurodia Industrie S.A. has established commercially viable ED technology for desalting of cane molasses, sugar beet syrup and liquid sugar. Lutin describes electrodialysis as a purification technology in the sugar industry especially to partially replace ion exchange resins for the demineralization and purification of sugar syrups (Zuckerindustrie 125, No 12, pp. 982-984, 2000 by Lutin). It should be noted that ion exchange technology does not provide an identical result to ED and that the regeneration of ion exchange resins necessarily involves the use of strong acids and bases while the ED resins are easily cleaned occasionally by an acid wash followed by an alkali wash with less chemicals than in ion exchange.

Further, alkali metal cations have been suspected of being highly melassigenic by holding sugar in the molasses and preventing it from being recovered as crystalline sugar. Elmidaoui et al. (Elsevier, Desalination 148, 2002, pp. 143-148) describe the removal of melassigenic ions especially Na⁺, K⁺ and Ca²⁺ for beet sugar syrups by electrodialysis using an anion-exchange membrane.

William J. Colonna et. al (Proceedings of Conference on Sugar Processing Research, New Orleans, April 1996) have identified some specific sugar odorants including pyrazines and suggested processes to remove odorants from beet sugar. In their experiments beet sugar odorants were removed using solid phase adsorbents, including Optipore (manufactured by Dow Chemical Company) a styrene-divinylbenzene resin derivatized with various functional groups, and Empore extractions disk (manufactured by the 3M Company) consisting of Teflon membranes derivatized with functional groups that bind specific organic compounds.

However, none of the above-mentioned prior art discloses a process wherein electrodialysis is used for removing malodorous volatile components from a beet sugar solution, wherein said solution contains malodorous volatiles as a result of one or more purification processes of sugar beet derived juices.

Despite the advances made in the art, there exists a continued need for the development of novel processes for the separation and recovery of sucrose components from beet sugar origin. Especially, there is a need to provide a brown food-grade sugar product from a beet sugar solution suitable for substituting the corresponding cane sugar derived products. The emphasis on “natural” foods in recent years has caused increased production of the darker types of breads and sweet goods, which often feature the inclusion of brown sugars and molasses. Both brown sugars and molasses based on cane are used in a wide variety of bakery foods for their contribution to flavour and colour in breads, cakes and cookies.

Many of the prior art approaches discussed hereinabove involve the use of electrodialysis especially for removal of salts and organic acids. However, in the prior art electrodialysis has not been used for removing malodorous volatile components that are a result of one or more earlier purification processes of a beet sugar solution. Especially, from the prior art it is not known to produce a food-grade molasses from sugar beet solution.

Thus, the objective problem to be solved is to provide brown food-grade sugar products having improved colour, taste, odour and/or aroma from a sugar beet solution.

### BRIEF DESCRIPTION OF THE INVENTION

An object of the present invention is thus to provide a process and a product so as to so as to alleviate the above disadvantages. The objects of the invention are achieved by a process, product and uses which are characterized by what is stated in the independent claims. The preferred embodiments of the invention are disclosed in the dependent claims.

The invention is based on the surprising finding that electrodialysis (ED) can be used for removing malodorous volatile components from a sugar beet solution. Especially, it was surprising that the undesired off-flavours and odours comprising pyrazines can be removed by ED. It was known from the prior art to use ED for removal of ionic compounds, but man skilled in the art would not have thought that non-ionic compounds such as pyrazines could be removed as well.

An objective of the invention is to provide a process of treating sugar beet juices and especially normal beet molasses to allow commercial food-grade brown sugar and molasses or blends thereof to be made suitable for use in both baking and confectionery. Now it has been found that electrodialysis removes undesired off-flavours and odours found in normal beet molasses from conventional sugar beet process. In this way a treated molasses can be produced suitable for direct production of food grade molasses absent of the off-odours normally associated with beet molasses. A further advantage of the process is that the ED treatment increases the molasses purity by removing salts, which allows extra sugar to be crystallised from the molasses. Crystallisation followed by centrifugation and drying of the recovered crystalline sugar allows production of brown sugar absent of the off-odours normally associated with brown sugar from sugar beet origin.

### BRIEF DESCRIPTION OF THE DRAWINGS

In the following the invention will be described in greater detail by means of preferred embodiments with reference to the attached drawings, in which

FIG. 1 is a schematic flow sheet of the inventive process according to an embodiment.

FIG. 2 is a schematic flow sheet of the inventive process according to another embodiment.

### SUMMARY OF THE INVENTION

“Sugar beet” (Beta vulgaris), a member of the Chenopodiaceae subfamily and the Amaranthaceae family, is a plant whose root contains a high concentration of sucrose. “Beet sugar” is sucrose obtained from sugar beet and respectively “beet molasses” is molasses obtained from sugar beet.

A typical beet sugar production process comprises several steps. After reception at the processing plant the beet roots are washed, mechanically sliced, and passed to a diffuser to extract their sugar content into a water solution. The liquid, a sugar beet solution, exiting the diffuser is called “raw juice”.

The raw juice contains many impurities that must be removed before crystallisation. These purifications processes do not only purify raw juice but also alter the chemical composition of the raw juice. As an example of the changes in the chemical composition is the formation of malodorous volatiles in the sugar beet solution. Although some of the malodorous volatiles probably enter the sugar factory with the beets, others such as organic acids and pyrazines are formed during processing. For example pyrazines (known malodorous compounds) are formed by the reaction of glucose with amino acids such as glutamine and lysine in purification by carbonation process.

A typical purification process in a sugar factory is “carbonation”, wherein the juice is first mixed with hot milk of lime (a suspension of calcium hydroxide in water). This treatment precipitates in some extent a number of impurities, including multivalent anions such as sulfate, phosphate, citrate and oxalate, which precipitate as their calcium salts and large organic molecules such as proteins, saponins and pectins, which aggregate in the presence of multivalent cations. In addition, the alkaline conditions convert the simple sugars, glucose and fructose, along with the amino acid glutamine, to chemically stable carboxylic acids and induce Maillard reaction and creation of unfavourable compounds like pyrazines. Left untreated, these sugars and amines would eventually frustrate crystallisation of the sucrose.

As a second step of carbonation, carbon dioxide can be introduced to the alkaline sugar solution, precipitating the lime as calcium carbonate (chalk). The chalk particles entrap some impurities and adsorb others. A recycling process builds up the size of chalk particles and a natural flocculation occurs where the heavy particles settle out in tanks. Further addition of carbon dioxide precipitates more calcium from solution, which can be filtered off, leaving a cleaner sugar solution called “thin juice”. The thin juice can be concentrated via multiple-effect evaporation to make a “thick juice”, having sucrose content roughly of 65% to 75% on dry weight.

The thick juice can be fed to crystallisers and concentrated further by boiling under vacuum in large vessels and seeded with fine sugar crystals. The resulting sugar crystal and syrup mix is called a “massecuite”. The massecuite is passed to a centrifuge where the “mother liquor” is removed from the sugar crystals (“A” crystallisation).

Remaining syrup (“high green”) can be rinsed off with water and the crystals dried in a granulator. The remaining syrup can be fed to another crystalliser from which a second batch of sugar is produced (“B” crystallisation). The syrup from the second (“low green”) crystalliser can be sent to a third crystalliser. There from a third batch of sugar is produced (“C” crystallisation) and syrup separated is typically molasses. All the main soluble impurities of thick juice are enriched to molasses. “Molasses” is defined according to Sugar Technology Beet and Cane Sugar Manufacture (Bartens, Berlin 1998, p. 1088) as the sugar-bearing product of the sugar end whose purity has been reduced to the point that further crystallisation of sugar is not economically feasible without special treatment of the molasses. European Union has in its regulation defined that food-grade molasses must contain less than 70% of DS (dry solids) of sugars (saccharose or its degradation products and other sugars like raffinose) to qualify as a molasses within EU-regulations.

In connection with the present invention molasses according any of the above definitions or according any other known definition are considered as molasses. Further, the above definitions terms “carbonation”, “raw juice”, “thick juice”, “thin juice”, “massecuite” and “mother liquor” should be considered as examples of definition of these terms and in connection with the present invention these terms are considered to include any other known definition in the art. As an example the amount of 2-ethyl-5 methyl pyrazines in beet based thick juice and molasses of conventional beet sugar process according to liquid-liquid extraction method used by Pihlsgard (J. Agric. Food chem. 2000, 48, 4844-4850) is 330 and 265 nanograms/g sugar (i.e. 0.330 ppm and 0.265 ppm) respectively. Measured by Kaipainen's dynamic headspace method (25th Int. Symp. On Capill. Chromatography, May 13-17.2002 Garda) sum of eight several pyrazines in refinery beet syrup has been 0.35 ppm (at pH 5.5) and in cane refinery molasses 0.001 ppm.

As a first aspect the present invention provides an industrially useful process for the recovery of a brown food-grade sugar product from a sugar beet solution. The process comprises i) providing a sugar beet solution, which contains malodorous volatiles as a result of one or more purification processes, ii) subjecting said sugar beet solution to electrodialysis to provide an electrodialyzed liquid, wherefrom malodorous volatiles are at least partly removed, and iii) recovering from said electrodialyzed liquid a product selected from liquid and solid brown sugar products of food-grade and combinations thereof.

Recovery of liquid and solid food-grade sugar products from electrodialyzed liquid can comprise concentration, crystallisation, drying, dilution or combinations thereof. Concentration can be effected by evaporation or membrane filtration. Liquid products are preferably concentrated to dry solids over 70%.

In order to enhance the removal of off-flavours from the sugar beet solution, said electrodialysis can be followed by a treatment with carbon or adsorbent resin to further remove off-flavours from said electrodialyzed liquid. Activated carbon can be either granular or powder qualities. If only polishing is desired following qualities can be chosen: Jacobi Aquasorb® (Jacobi Carbons Ltd), Norit® Rox 0,8 or Norit® Darco (Norit N.V). If also color removal is a target e.g. Chemiviron CPG (Chemviron Carbon Ltd.) quality can be used. As an example of suitable adsorbent resin Optipore® (manufactured by Dow Chemicals) can be mentioned. Carbon or adsorbent treatment can be carried out e.g. in temperatures up to 80° C. and in concentrations up to 80% and preferably at pH below pH 9.

In an embodiment of the invention the purification process comprises treatment of sugar beet juice under alkaline conditions such as the above-mentioned carbonation. The sugar beet solution can be derived from the sugar beet juice by one or more processes selected from dilution, evaporation, crystallisation and combinations thereof and the sugar beet solution can comprise thick juice, thin juice, massecuite, mother liquor, high greens, low greens, molasses and combinations thereof. The resulting sugar beet solution may contain varying amounts of pyrazines depending on the used raw materials and purification conditions.

In an embodiment of the process the sugar beet solution is subjected to electrodialysis, which is operated for removing at least 20%, preferably 30% or more of the total volatiles initially contained in said solution. Especially said electrodialysis is operated for removing pyrazines initially contained in said sugar beet solution.

In another embodiment said electrodialysis is effective in removing 50% or more, preferably between 60 and 90% of the pyrazines initially contained in said sugar beet solution. In a specific embodiment the sugar beet solution contains methyl pyrazine and 2,5-methyl pyrazine and more than 80%, preferably 90% or more of said methyl pyrazine is removed and more than 50%, preferably 70% or more of the 2,5-dimethyl pyrazine is removed.

In an embodiment of the invention the electrodialysis comprises feeding said sugar beet solution at the dry solids concentration 10% to 50%, preferably 25% to 35% through anion and cation exchange membranes, which operate above 40° C., preferably between 55 to 65° C. Examples of suitable anion exchange membranes comprise organic fouling resistant and temperature resistant Neosepta® AXE01 (Tokuyama Corp./Eurodia) and examples of suitable cation exchange membranes comprise Neosepta® CMX (Tokuyama Corp./Eurodia). In an embodiment the sugar beet solution is subjected to electrodialysis at a pH between 6 and 9, preferably between 6.7 and 8, and the pH of said liquid after electrodialysis is between pH 4 and 6, preferably between 4.5 and 5.

In accordance with the present invention the electrodialysis can also be operated to remove salts from said sugar beet solution. In a specific embodiment the electrodialysis is operated to remove at least 40%, preferably 60% or more of the inorganic and organic anions and cations and organic acids initially contained in said sugar beet solution.

As mentioned the present invention provides an industrially useful process for the recovery of a brown food-grade sugar product from a sugar beet solution, wherein the product is selected from liquid and solid brown, food-grade sugar products and combinations thereof. In an embodiment said recovery includes crystallisation and said solid food-grade sugar comprises brown sugar. The crystallisation can be selected from evaporative boiling crystallisation and cooling crystallisation and combinations thereof. The obtained brown sugar can be further refined by crystallisation to provide white sugar and “brown sugar molasses”.

In another embodiment said recovery is concentration by evaporation and a liquid food-grade sugar product is selected from food-grade molasses, treacle and syrup.

In an embodiment the sugar beet solution is beet molasses and it is subjected to electrodialysis, carbon or adsorbent resin treatment, and crystallisation, in that order, and a product selected from brown sugar and secondary electrodialyzed carbon-treated molasses is/are recovered after said crystallisation.

In another embodiment said sugar beet solution is beet molasses and it is subjected to electrodialysis, crystallisation and carbon or adsorbent resin treatment, in that order, and brown sugar is recovered after the crystallisation and carbon treated secondary electrodialyzed molasses is recovered after said carbon or adsorbent resin treatment.

Preferably the brown sugar and the secondary electrodialyzed molasses of various options are recovered essentially free of the off-flavours and the burnt solvent odours found in normal brown sugar and molasses from sugar beet.

The obtained brown sugar can be further subjected to a treatment selected from drying, granulation, grinding, blending, coating and combinations thereof to provide a brown sugar product useful as a substitute for brown sugar products from sugar cane, and the obtained electrodialyzed molasses can be further subjected to a treatment selected from blending, inversion and combinations thereof to provide a molasses product useful as a substitute for molasses, treacle, syrup and soft brown sugar of sugar cane origin.

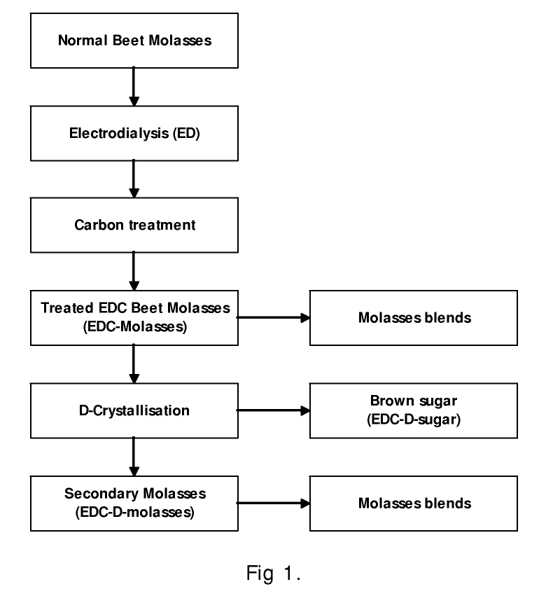

In an embodiment of the invention as illustrated in FIG. 1, a solution of sugar beet molasses preferably from a conventional beet sugar process is subjected to electrodialysis (ED) to provide an electrodialyzed liquid, wherefrom malodorous volatiles are at least partly removed. The obtained electrodialyzed solution can be treated with carbon and the electrodialyzed carbon treated (EDC) liquor is recovered as EDC-molasses. This EDC-molasses is a food-grade beet molasses that can be used as such as an ingredient, sweetener, flavourant and/or colourant in a nutritional, nutraceutical or pharmaceutical product.

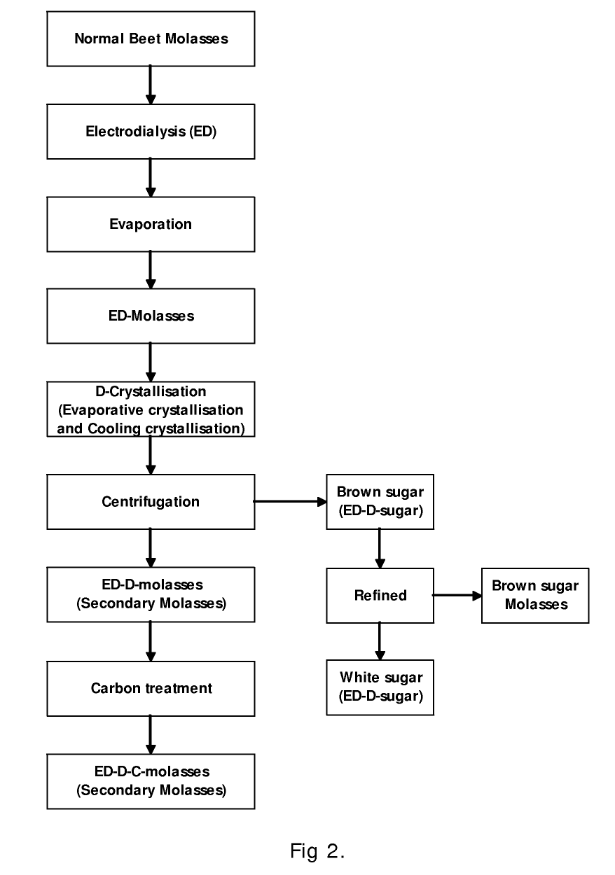

On the other hand the obtained electrodialyzed solution from beet molasses can be subjected to at least one crystallisation (D-crystallisation) (FIG. 2). The crystallisation separates the sugar from the organic and inorganic components in the sugar solution. The sugar crystals are removed by centrifugation to provide crystallized sucrose (ED-D-sugar) and secondary electrodialyzed molasses (ED-D-Molasses). The crystallized sucrose (ED-D-sugar) is recovered as brown sugar, which can be used as such as an ingredient, sweetener, flavourant and/or colourant in a nutritional, nutraceutical or pharmaceutical product. The brown sugar (ED-D-sugar, brown) can be refined by crystallisation to provide white sugar (ED-D-sugar, white) and “brown sugar molasses”. The secondary electrodialysed (ED-D) molasses is also recovered and it can be used for example as treacle and/or for making acrylamide-free soft brown sugar. Further purification of ED-D molasses can be effected by carbon treatment to obtain a carbon treated secondary electrodialyzed molasses (ED-D-C).

The obtained brown liquid or solid food-grade sugar product can be mixed with other ingredient(s) and processed into an edible product selected from a dessert, ice-cream, confectionery, bakery, beverage and table sugar.

As a second aspect the invention provides use of electrodialysis for removing malodorous volatile components from a sugar beet solution, which contains malodorous volatiles as a result of one or more purification processes. In a specific embodiment said electrodialysis is used for removing pyrazines from said solution. Especially electrodialysis is used for sugar beet solutions containing methyl pyrazine and 2,5-methyl pyrazine, and by the use of electrodialysis more than 80%, preferably 90% or more of said methyl pyrazine is removed and more than 50%, preferably 70% or more of the 2,5-dimethyl pyrazine is removed.

In an embodiment the use of electrodialysis is combined with a carbon or adsorbent resin treatment for removing off-flavours. Especially the use of electrodialysis is for providing a beet-derived brown sugar and/or molasses suitable for substituting the corresponding product derived from cane sugar.

As a third aspect the invention provides a food-grade sugar beet product derived from a sugar beet solution, which contains malodorous volatiles as a result of one or more purification processes, said product comprising a brown sugar or molasses product, which contains less than 0.5 ppm, preferably less than 0.15 ppm, volatile pyrazines and is essentially free of saponins or at least less than 50 mg/kg of molasses. Preferably said product is essentially free of methyl pyrazine.

In an embodiment the food-grade sugar beet product is derived from a sugar beet solution wherefrom the pyrazines contained therein have been removed by electrodialysis. Preferably the product contains no more than 50%, preferably no more than 30% of the 2,5-dimethyl pyrazine initially contained in said solution.

In another embodiment the food-grade sugar beet product is derived from beet molasses which has been purified by electrodialysis and carbon treatment.

Typically electrodialyzed molasses produced according to the invention is finally concentrated to the range from 68% to 80% dry solids (DS) to provide food-grade beet molasses, treacle or syrup,. It which contains sucrose 55 to 75% on DS, conductivity ash below 7% on DS, preferably below 4% on DS, and pyrazines less than 0.5 ppm measured by Dynamic headspace method TCT.GC-MS (Kaipainen A. J of High Res. Chromatogr. 1992, p 751-755), preferably less than 0.15 ppm. Final product has dark or semi dark colour and pleasant flavour.

The product according to the invention is preferably a beet derived product selected from brown sugar, electrodialyzed molasses, treacle, syrup and combinations thereof having colour, taste, odour and aroma acceptable to be used in food industry analogous to various corresponding cane sugar based brown sugar and molasses grades. In an embodiment the brown sugar product according to the invention is selected from soft brown sugar, coated brown sugar and free-flowing brown sugar. In a specific embodiment said brown sugar has a colour ranging from 3000 to 11000 ICUMSA units and brown sugar product contains less than 0.01 ppm volatile pyrazines.

The invention also concerns an edible product, which is a nutritional, nutraceutical or pharmaceutical product comprising a brown sugar and/or molasses product according to the invention as ingredient, sweetener, flavourant and/or colourant. In an embodiment the edible product comprises a blend of said brown sugar and/or molasses with cane sugar derived sugar and/or molasses. Examples of edible products comprise desserts, ice-cream, confectionery, bakery and beverages.

The food-grade sugar beet products according to the invention can be used as an ingredient, sweetener, flavourant and/or colourant in a nutritional, nutraceutical or pharmaceutical product.

The invention is illustrated further in the following Examples. It should be understood that this is done solely by way of example and is not intended neither to delineate the scope of the invention nor limit the ambit of the appended claims.

### EXAMPLES

### Example 1

Example 1 comprises the following steps:
1) Electrodialysis (ED) of normal sugar beet factory molasses producing a purified ED-molasses with reduced odour and off-taste;
2) Carbon treatment of purified ED-molasses producing treated EDC-molasses essentially free of off-odours and off-tastes, suitable for making molasses blends;
3) Evaporative crystallisation of the purified and carbon treated EDC-molasses producing an EDC-massecuite;
4) Centrifugation of the EDC-massecuite producing a brown sugar and an EDC-D-molasses exhausted of sugar and similar in purity to normal factory molasses.

The composition of the beet molasses fed to the ED unit was analysed as follows:

| | |
|---|---|
| Pol, % | 49.1 |
| Refractive Dry Substance (RDS), % | 79.0 |
| Pol purity, % | 62.2 |
| Invert sugar, % on RDS | 0.7 |
| Conductivity ash, % | 11.5 |
| pH | 6.7 |
| Colour, I CUMSA | 74,000 |

Pol = The apparent sucrose content expressed as a percentage by mass and determined by polarisation method.
Pol Purity = The percentage ratio of pol to the total soluble solids in a sugar product.

Electrodialysis:

The feed molasses was first diluted from 79.0% refractometer dry substance (RDS) to about 30% RDS before being fed to the Electrodializer Pilot Plant, EUR 20 B 200-10, constructed in co-operation with Eurodia Industrie SA using Neosepta® AXE01 and CMX exchange membranes. A 70% reduction in conductivity was achieved at an operating temperature of 55° C. using a current density of 7 mA/cm² and 1V/cell. Afterwards the ED molasses was pH adjusted to a neutral pH using sodium hydroxide and re-concentrated in a falling-film evaporator.

Analysis of the ED treated and evaporated molasses gave the following results:

| | |
|---|---|
| Pol, % | 50.4 |
| Refractive Dry Substance (RDS), % | 69.1 |
| Pol purity, % | 72.9 |
| Invert sugar, % on RDS | 1.1 |
| Conductivity ash, % | 3.5 |
| pH | 6.9 |
| Colour, I CUMSA | 76,600 |

ED increased the molasses sucrose purity by almost 11 units and significantly reduced the salty, sour, bitter, and beet tastes in the molasses. It also eliminated the unpleasant burnt solvent odour. The ED-molasses was thereafter subjected to carbon treatment.

Carbon Treatment:

The ED molasses was fed into an AquaFlow™ AF700 modular filter unit filled with Jacobis Aquasorb® H200 carbon. The filter was supplied pre-filled with 300 kg of carbon. The process was operated at 70° C. at a flow rate of 150 litres per hour.

Analysis of the resultant carbon treated EDC-molasses gave the following results:

| | |
|---|---|
| Pol, % | 50.8 |
| Refractive Dry Substance (RDS) | 69.0 |
| Pol purity, % | 73.7 |
| Invert sugar, % on RDS | 1.1 |
| Conductivity ash, % | 3.5 |
| pH | 7.3 |
| Colour, I CUMSA | 76,100 |

Carbon treatment further reduced beet taste and all off-odour exposing some pleasant chocolate-like notes.

Crystallisation:

A 300 litre pilot DDS type evaporative batch crystalliser with stirrer was used. The carbon treated EDC-molasses was concentrated under vacuum at 80° C. and seeded with sugar crystals. These were grown by further concentration for about ten hours exhausting the EDC-molasses of crystallisable sucrose. The hot massecuite was then centrifuged and the sugar crystals removed from the final exhausted molasses.

Analysis of this final molasses or EDC-D-molasses gave the following results:

| | |
|---|---|
| Pol, % | 53.1 |
| Refractive Dry Substance (RDS), % | 79.4 |
| Pol purity, % | 66.9 |
| Invert sugar, % on RDS | 1.3 |
| pH | 6.8 |
| Colour, I CUMSA | 105,800 |

The purity of the EDC-D-molasses could have been further reduced if the massecuite had been cooled to 45° C. before centrifugation as normally done on a factory-scale to maximise crystal yield.

Analysis of the brown EDC-D-sugar gave the following results:

| | |
|---|---|
| Pol purity, % | 96.3 |
| Colour, I CUMSA units | 11,100 |
| Conductivity ash, % | 0.69 |
| Invert sugar, % on RDS | 0.17 |

The EDC-D-sugar had both a pleasant mild sweet taste and a pleasing visual red-brown appearance.

Aroma Profile Analysis:

Analysis of Volatile Organic Compounds by Dynamic Headspace TCT-GC-MS was done on beet molasses after ED-treatment (ED) and after ED and carbon treatment (ED-C). A total of 27 volatile compounds were identified and semi-quantified in all three samples. Some of the identified compounds were present in concentrations exceeding their odour threshold. The total amount of the volatiles is significantly reduced after ED and ED-carbon treatment (see table below).

Volatile Organic Compounds Identified in molasses and treated by TCT-GC-MS (Analytical results for volatiles are mg/kg on as is bases):

| Beet Molasses | | Normal | ED | ED-C |
|---|---|---|---|---|
| compound | (min) | (mg/kg) | (mg/kg) | (mg/kg) |
| Refractive dry substance, % | | 79 | 69 | 69 |
| 2-Methyl-Propanal | 2.39 | | | 0.02 |
| 2-Methyl-Butanal | 3.50 | 0.03 | 0.25 | 0.16 |
| 3-Methyl-Butanal | 3.59 | 0.02 | 0.11 | 0.07 |
| Ethanol | 3.99 | 0.06 | | |
| Dimethyldisulfide (DMDS) | 7.97 | 0.02 | 0.01 | 0.01 |
| Pyrinide | 13.33 | 0.01 | | |
| 2-Methyl-1-Butanol | 13.51 | 0.01 | | |
| Di-Hydroxy-2-Methyl-3-Furanone | 15.24 | | 0.09 | 0.06 |
| Methyl Pyrazine | 15.24 | 0.30 | | |
| 3-OH-2-Butanone (=Acetoin) | 16.26 | 0.04 | 0.04 | 0.02 |
| 1-OH-2-Propanone (=Acetol) | 16.83 | 0.45 | 0.56 | 0.15 |
| 2,5-Di-Methyl Pyrazine | 17.09 | 0.16 | 0.05 | 0.07 |
| 2,6-Di-Methyl Pyrazine | 17.33 | 0.10 | 0.02 | 0.03 |
| 2,3-Di-Methyl Pyrazine | 17.91 | 0.07 | | |
| 2-Ethyl-6-Methyl-Pyrazine | 19.25 | 0.07 | 0.02 | 0.01 |
| 2-Ethyl-5-Methyl-Pyrazine | 19.42 | 0.04 | | |
| Trimethyl Pyrazine | 19.84 | 0.23 | 0.04 | 0.02 |
| 2-Ethyl-2,5-Di-Methyl Pyrazine | 21.18 | 0.03 | | |
| 2,6-Di-Ethyl-Pyrazine | 21.71 | 0.02 | | |
| Acetid Acid | 22.76 | 0.23 | 0.25 | 0.09 |
| Butyrolactone | 26.98 | 0.06 | 0.06 | 0.01 |
| 2-Furanmethanol | 28.23 | 0.03 | 0.03 | |
| 5-Methyl-2-Furanmethanol | 29.92 | 0.04 | 0.02 | |
| 2-OH-3-Me-2-Cyclopenten-1-One | 32.69 | 0.01 | | |
| Amino Acid | 33.41 | 0.01 | | |
| 2-Methoxy-Phenol (=Mequinol) | 33.53 | 0.01 | | |
| 2-Pyrrolidinone | 37.72 | 0.01 | | |
| Sum | | 2.07 | 1.6 | 0.7 |

a) Tentative identification, by mass spectrum library only, no model compounds analysed.
b) Approximate concentration level, calculated using ISTD only, one digit valid only.
c) Empty cell = not detected, detection limit about 0.005 mg/kg.
d) 2-Methyl-Propanal = Isobutyraldehyde; Mequinol = 2-Methoxy-Phenol

From the above table the total amounts of pyrazines can be calculated in each case. The normal beet molasses contains about 1.02 mg/kg of pyrazines, whereas the ED treated molasses contains only about 0.15 mg/kg of pyrazines. The carbon treatment reduces even further the total amount pyrazines. The ED and carbon treated molasses contains about 0.13 mg/kg of pyrazines.

Sensory Analysis:

Sensory analysis by both sniffing and tasting was done to evaluate both odours and flavours of the beet molasses and brown sugar before and after ED and carbon treatment. The most significant improvement was removal of the pungent burnt solvent odour present in normal untreated beet molasses. This enabled brown sugar to be produced from treated molasses absent of a pungent burnt solvent odour, which is otherwise not possible from normal beet molasses.

The ED treatment significantly reduced the sour taste of the molasses, while both ED and carbon treatments removed bitter taste. The removal of the pungent burnt solvent odour and sour and bitter tastes allowed more pleasant caramel and surprising chocolate notes to become noticeable as well as a slight liquorice taste.

Sensory analyses indicated EDC-molasses as a suitable for molasses blends, ice-cream, toffee, soft brown sugar and for making granulated brown sugar.

### Example 2

Example 2 comprises the following steps as shown in FIG. 2:
1) Electrodialysis (ED) of normal untreated sugar beet factory molasses to produce a purified ED-molasses;
2) Evaporative crystallisation of the purified ED-molasses on factory-scale using a 30 m³ batch vacuum pan to produce an ED-D-massecuite;
3) Cooling crystallisation of the ED-D-massecuite from 80° C. to 50° C. over 48 hours by natural cooling in a stirred strike receiver;
4) Centrifugation of the ED-D-massecuite by a continuous centrifuge producing a brown sugar and an ED-D-molasses exhausted of sugar and of similar purity to normal untreated factory molasses;
5) Refining of the brown sugar to white sugar in the traditional way by re-dissolving and re-crystallisation;
6) Carbon treatment of the ED-D-molasses to produce and ED-D-C-molasses.

The process steps are illustrated in the block diagram in FIG. 2.

Electrodialysis:

The feed molasses was diluted from 77.8% refractometer dry substance (RDS) to about 30% RDS before being fed to the Electrodializer Pilot Plant, EUR 20 B 200-10 using Neosepta®AXE01 and CMX exchange membranes. A 60% reduction in conductivity from 20 to 8 mS/cm was achieved at an operating temperature of 55° C. using a current density of 7 mA/cm2 and 1V/cell.

Analysis of the molasses before and after ED gave the following results:

| Analysis | ED Feed Molasses | ED-Molasses |
|---|---|---|
| RDS % | 32.5 | 28.1 |
| Sucrose purity, % on RDS | 60.8 | 70.7 |
| Glucose, % on RDS | 0.2 | |
| Fructose, % on RDS | 0.5 | |
| Potassium, % on RDS | 4.5 | |
| Conductivity ash % RDS | 11.6 | 4.0 |
| Colour, I CUMSA | 62,370 | 69,120 |
| pH | 7.3 | 4.9 |

ED increased sucrose purity of molasses from 60.8% up to 70.7% on RDS. There was no colour removal. The pH of product molasses was immediately increased from 4.9 to 8.1 with sodium hydroxide to avoid sucrose inversion. The ED product molasses was evaporated in a falling-film evaporator from 28.1% to 74.6% RDS.

Crystallisation:

The ED product molasses was subjected to a single evaporative crystallisation at 80° C. in a 30 m³ stirred vacuum pan with centre down-take. The same procedure as for final product crystallisation was used.

After evaporative crystallisation the massecuite was discharged into a strike receiver tank and cooled naturally under stirring to 50° C. over a period of 48 hours. Thereafter the massecuite was centrifuged in a continuous machine. The sugar crystals were separated, dissolved and recycled to the white sugar boiling pans. ED-D-molasses was separated from the sugar crystals and collected.

Analysis gave the following results:

| Analysis of ED-D-molasses | % On RDS |
|---|---|
| Sucrose | 58.6 |
| Glucose | 0.3 |
| Fructose | 0.4 |
| Potassium | 2.3 |

The results show the ED-D-molasses to have a about 2%-units lower sucrose content (58.6%) compared to the original untreated molasses (60.8%).

Analysis of the ED-D-sugar recovered by centrifugation gave the following results:

| Analysis of ED-D-sugar | |
|---|---|
| Pol purity, % | 96.3 |
| Colour, I CUMSA | 8,660 |
| Conductivity ash, % on RDS | 0.60 |

Carbon Treatment:

The ED-D-molasses was first conditioned by diluting to 58% to 60% RDS and heating to 60° C. before being fed into a column filled with one litre of Chemviron CPG carbon at a flow rate of 500 mL/h. 13 litres of ED-D-molasses were treated over a period of 26 hours. The results of the analyses made before (ED-D-molasses) and after the carbon treatment (ED-D-C-molasses) were as follows:

| Analysis | ED-D-Molasses | ED-D-C-Molasses |
|---|---|---|
| Sucrose purity, % on RDS | 59.1 | 60.0 |
| Conductivity ash, % on RDS | 6.6 | 6.7 |
| Colour, I CUMSA | 107,770 | 94,149 |
| pH | 6.9 | 7.0 |

The carbon treatment removed a little colour and slightly increased the purity of the ED-D-C-molasses, but had minor effect on the ash and pH levels. The carbon treatment produced an ED-D-C-molasses free of off-flavours normally associated with normal beet molasses.

### Example 3

Example 3 comprised blending the carbon treated EDC-D-molasses, produced as explained in example 1, to food-grade cane molasses.

ED and carbon treated beet molasses lacks some of the significant liquorice and salmiac taste of cane molasses needed to spice up liquorice-type dark candies. To make a product suitable for making liquorice, the ED and carbon treated beet molasses was blended to food-grade cane molasses at levels of up to 30%.

Sensory tests of the blends were made by a panel of 28 participants. The judgement was EDC-molasses could be blended in the amount of 20-30% with food-grade cane without losing the desired liquorice and salmiac tastes necessary for making liquorice.

### Example 4

Example 4 comprised making ice cream with EDC-molasses according to Example 1 as an ingredient as follows:

| | % |
|---|---|
| COMPOSITION IN PERCENTAGES | |
| Cream (38% fat) | 21.00 |
| Skimmed milk powder | 7.30 |
| Whey powder | 2.50 |
| Sucrose | 12.00 |
| Glucose syrup powder 32 DE, 95% TS. | 4.00 |
| CREMODAN ® SE 30 Emulsifier & Stabiliser System | 0.55 |
| Annatto Extract (orange) | 0.05 |
| Water (Tap) | 50.90 |
| EDC-Molasses | 1.60 |
| Total percentage | 100.00 |
| COMPOSITION | |
| Total Fat | 8.45 |
| Total MSNF (milk solid non fat) | 10.49 |
| Total Dry Matter | 35.85 |
| Total Carbohydrate | 22.01 |
| Total Protein | 3.33 |
| FPDF (freezing point depression factor) | 21.56 |
| FPDF minus lactose | 15.36 |
| Rel S | 14.54 |
| Factor | 16.36 |
| Freezing Point | −2.12 |
| Density | 1.10 |

Ice cream process:
1. Mix liquid ingredients at 20-22° C.
2. Mix dry ingredients and add to water phase at 20-22° C.
3. Add flavouring and colouring
4. Increase temperature to 70° C. during mixing
5. Homogenise at: 78° C./200 bar
6. Pasteurise at: 84° C./30 sec on the plate heat exchanger
7. Cool to 5° C.
8. Ageing overnight in ice water
9. Freezing, drawing temperature 5.0° C., light extrusion with 100% overrun
10. Fill
11. Overnight freezing in hardening tunnel at −30° C.
12. Store at −25° C.

The ice cream was judged to have a good, full caramel taste plus a slight liquorice taste. It could easily have tolerated a higher dosage of EDC-molasses.

### Example 5

Example 5 comprised making toffee with EDC-molasses according to Example 1 as an ingredient as follows:

1 dl cream

1 dl EDC-molasses

The ingredients were stirred in a microwave safe bowl and put in the microwave oven at full effect (750 W) for about 80-90s. When the toffee was ready the mixture was poured on a greased baking tray paper and cooled down before being cut into pieces.

The toffee had a good taste with pleasant chocolate/cocoa after notes.

### Example 6

Example 6 comprised making bakery molasses as follows:
1) The concentration of EDC-molasses (according Example 1) was adjusted to 65% RDS;
2) The pH was adjusted to between 4.0 and 5.6 with 6% HCl;
3) 1.3 kg of the EDC-molasses was heated to 60° C.;
4) 2 mL of enzyme solution (invertase from Baker's yeast) was added;
5) The mixture was stored in a warm oven at 70° C. for 48 hours to allow the sucrose to be inverted.
6) The enzyme activity was then stopped by heat treatment at 90 to 95° C. for 30 minutes.
7) The desired invert level was achieved by blending the original and the inverted EDC-molasses in amounts giving a desired pol purity of −25 units.
8) The pH was then adjusted to between 5.6 and 6.0 with 45% sodium hydroxide.
9) The concentration was adjusted to ˜79% RDS by evaporation under vacuum.

The inversion process gave the EDC-molasses a sweeter and milder taste making it suitable as a Bakery Molasses.

### Example 7

Example 7 comprised making dark soft brown sugar by blending 9kg of EDC-D-sugar (according to Example 1) with 1 kg of EDC-molasses.

The analysis of the resultant product was as follows:

| | |
|---|---|
| Sucrose content in % | 90.7 |
| Invert sugar content in % | 0.2 |
| Ash content in % | 0.9 |
| Water content in % | 3.0 |
| Colour, I CUMSA | 16,200 |

The product had a pleasing reddish brown colour and a distinctive sweet mild taste.

### Example 8

Soft liquorice is normally made from food molasses of cane origin. In Example 8 soft liquorice is made from the ED-D-C-molasses product of beet origin as produced in example 2 as follows:

Formulation:

| | | % |
|---|---|---|
| A | Wheat flour | 21.0 |
| | Water | 23.9 |
| | Liquorice powder | 2.4 |
| B | Partially inverted Sugar | 41.9 |
| | Solution | |
| | Food Molasses | 10.5 |
| | Carbon Black | 0.18 |
| | Salt | 0.09 |
| C | Aniseed oil | 0.03 |

Process:
1. Mix wheat flour, liquorice powder and water homogenous slurry.
2. Add into the cooker sugar solution, half of the food molasses and the slurry. Heat to boiling point and add the rest of the food molasses, carbon black and salt.
3. Cook until the dry substance (RDS) is 70 to 75%.
4. Add aniseed oil after heating has been stopped and mix for 5 minutes.
5. Take liquorice mass out.
6. Form during following day or when the temperature is about 90° C.
7. Dry the formed liquorice in cabins at 40 to 50° C. Water content in product is 17 to 20%.

Trials:

Three different trials were done replacing in formula 10%, 30% and 100% of Cane Food Molasses with ED-D-C-molasses. Technically processing of all trials was similar to the reference sample. The taste profile of 10% and 30% replacement was also as good as the reference. The strong liquorice taste masked slight differences noticed in pure Cane Food Molasses with 30% ED-D-C-molasses.

The taste profile of the test sample of 100% replacement was slightly different. No odd flavour, but the taste profile was poorer and more narrow and milder than that of cane molasses.

### Example 9

### Comparison Results

Comparison analyses of molasses of present invention (Example 1) and molasses from process using UF and ED for purification of sugar beet raw juice.

Analysis of volatile compounds by Dynamic Headspace TCT-GC-MS of (a) ED-treated beet molasses from the traditional juice purification process (carbonation) and (b) beet molasses produced according to the process described in WO2003/018848 by purifying raw juice with membrane filtration (UF) and ED-treatment are shown in the following table.

The level of saponins was for molasses of the present invention 43 mg/kg of molasses and for UF-ED treated molasses 164 mg/kg of molasses.

| | Reference molasses | Invention |
|---|---|---|
| | UF/ED process | ED-molasses |
| Compound | (mg/kg) | (mg/kg) |
| 1-Hydroxy-2-Propanone (=Acetol) | 0.06 | 0.56 |
| 2,5-Dimethyl-Pyrazine | | 0.05 |
| 2,6-Dimethyl-Pyrazine | | 0.02 |
| 2-Ethyl-6-Methyl-Pyrazine | | 0.02 |
| Trimethyl-Pyrazine | | 0.04 |

Empty cell = not detected, detection limit about 0.005 mg/kg

1. An industrially useful process for the recovery of a brown food-grade sugar product from a sugar beet solution comprising
providing a sugar beet solution, which contains malodorous volatiles as a result of one or more purification processes;
subjecting said sugar beet solution to electrodialysis to provide an electrodialyzed liquid, wherefrom malodorous volatiles are at least partly removed; and
recovering from said electrodialyzed liquid a product selected from liquid and solid brown sugar products of food-grade and combinations thereof.

2. Process according to claim 1, wherein in order to enhance the removal of off-flavours from said sugar beet solution, said electrodialysis is followed by a treatment with carbon or adsorbent resin to further remove off-flavours from said electrodialyzed liquid.

3. Process according to claim 1, wherein said one or more purification processes comprises treatment of sugar beet raw juice under alkaline conditions.

4. Process according to claim 1, wherein said purification process is a carbonation process.

5. Process according to claim 3, wherein said sugar beet solution is derived from said sugar beet juice by one or more processes selected from dilution, evaporation, crystallisation and combinations thereof.

6. Process according to claim 5, wherein said sugar beet solution comprises beet molasses.

7. Process according to claim 1, wherein said electrodialysis is operated for removing at least 20%, preferably 30% or more of the total volatiles initially contained in said solution.

8. Process according to claim 1, wherein said malodorous volatiles comprise pyrazines.

9. Process according to claim 1, wherein said electrodialysis is operated for removing pyrazines initially contained in said sugar beet solution.

10. Process according to claim 9, wherein said electrodialysis is effective in removing 50% or more, preferably between 60 and 90% of the pyrazines initially contained in said sugar beet solution.

11. Process according to claim 9, wherein said sugar beet solution contains methyl pyrazine and 2,5-methyl pyrazine and more than 80%, preferably 90% or more of said methyl pyrazine is removed and more than 50%, preferably 70% or more of the 2,5-dimethyl pyrazine is removed.

12. Process according to claim 1, wherein said recovery includes crystallisation and said solid food-grade sugar comprises brown sugar.

13. Process according to claim 1, wherein said recovered liquid brown food-grade sugar product is selected from food-grade molasses, treacle and syrup.

14. Process according to claim 12, wherein said brown sugar is refined by crystallisation to provide white sugar and secondary electrodialyzed molasses.

15. Process according to claim 1, wherein said electrodialysis comprises feeding said sugar beet solution through anion and cation exchange membranes, which operate above 40° C., preferably 55-65° C.

16. Process according to claim 15, wherein said anion exchange membrane comprises a fouling resistant and temperature resistant Neosepta®AXE01.

17. Process according to claim 15, wherein said cation exchange membrane comprises a Neosepta® CMX.

18. Process according to claim 1, wherein the electrodialysis comprises feeding said sugar beet solution at the dry solids concentration 25% to 35% through anion and cation exchange membranes.

19. Process according to claim 1, wherein said sugar beet solution is subjected to electrodialysis at a pH between 6 and 9, preferably between 6.7 and 8.

20. Process according to claim 19, wherein the pH of said liquid after electrodialysis is between pH 4 and 6, preferably between 4.5 and 5.

21. Process according to claim 1, wherein said electrodialysis is operated to also remove salts from said sugar beet solution.

22. Process according to claim 21, wherein said electrodialysis is operated to remove at least 40%, preferably 60% or more of the inorganic and organic anions and cations and organic acids initially contained in said sugar beet solution.

23. Process according to claim 12, wherein said crystallisation is selected from evaporative boiling crystallisation and cooling crystallisation and combinations thereof.

24. Process according to claim 12, wherein said sugar beet solution is beet molasses and it is subjected to electrodialysis, carbon or adsorbent resin treatment, and crystallisation, in that order, and a product selected from brown sugar and secondary electrodialyzed carbon-treated molasses is/are recovered after said crystallisation.

25. Process according to claim 12, wherein said sugar beet solution is beet molasses and it is subjected to electrodialysis, crystallisation and carbon or adsorbent resin treatment, in that order, and brown sugar is recovered after said crystallisation and carbon-treated secondary electrodialyzed molasses is recovered after said carbon or adsorbent resin treatment.

26. Process according to claim 24, wherein said brown sugar and said electrodialyzed carbon-treated molasses are recovered essentially free of the off-flavours and the burnt solvent odours found in normal brown sugar and molasses from sugar beet.

27. Process according to claim 26, wherein said brown sugar is subjected to a treatment selected from drying, granulation, grinding, blending, coating and combinations thereof to provide a brown sugar product useful as a substitute for brown sugar products from sugar cane.

28. Process according to claim 26, wherein said electrodialyzed molasses is subjected to a treatment selected from blending, inversion and combinations thereof to provide a molasses product useful as a substitute for molasses, treacle, syrup and soft brown sugar of cane sugar origin.

29. Process according to claim 1, wherein said liquid or solid brown sugar product of food-grade is mixed with other ingredient(s) and processed into an edible product selected from a dessert, ice-cream, confectionery, bakery, beverage and table sugar.

30. (canceled)

31. (canceled)

32. (canceled)

33. (canceled)

34. (canceled)

35. A food-grade sugar beet product derived from a sugar beet solution, which contains malodorous volatiles as a result of one or more purification processes, said product comprising a brown sugar or molasses product, which contains less than 0.5 ppm volatile pyrazines and is essentially free of saponins.

36. A food-grade sugar beet product according to claim 35, wherein said molasses product contains less than 0.15 ppm volatile pyrazines.

37. A food-grade sugar beet product according to claim 35, wherein said brown sugar product contains less than 0.01 ppm volatile pyrazines.

35. A food-grade sugar beet product derived from a sugar beet solution, which contains malodorous volatiles as a result of one or more purification processes, said product comprising a brown sugar or molasses product, which contains less than 0.5 ppm volatile pyrazines and is essentially free of saponins.

36. A food-grade sugar beet product according to claim 35, wherein said molasses product contains less than 0.15 ppm volatile pyrazines.

37. A food-grade sugar beet product according to claim 35, wherein said brown sugar product contains less than 0.01 ppm volatile pyrazines.

38. Product according to claim 35, wherein pyrazines contained in said sugar beet solution have been removed by electrodialysis.

39. Product according to claim 35, which is essentially free of methyl pyrazine.

40. Product according to claim 38, which contains no more than 50%, preferably no more than 30% of the 2,5-dimethyl pyrazine initially contained in said solution.

41. Product according to claim 35, which is derived from beet molasses and which has been purified by electrodialysis and carbon treatment.

42. Product according to claim 35, which is a brown sugar product selected from soft brown sugar, coated brown sugar and free-flowing brown sugar.

43. Product according to claim 42, wherein said brown sugar has a colour ranging from 3000 to 11000 ICUMSA units.

46. Edible product according to claim 45, which comprises an edible product selected from desserts, ice-cream, confectionery, bakery and beverages.

47. Edible product according to claim 45, which comprises a blend of said brown sugar and/or molasses with cane sugar derived sugar and/or molasses.

48. (canceled)
